(19) United States
(12) Patent Application Publication
(10) Pub. No.: US 2024/0179811 A1
(43) Pub. Date: May 30, 2024

(54) COOKING ASSEMBLY FOR A MICROWAVE OVEN

(71) Applicant: WHIRLPOOL CORPORATION, BENTON HARBOR, MI (US)

(72) Inventors: Lin Ge, Shenzhen (CN); Jianan Hu, Foshan (CN); Xin Li, Shenzhen (CN); Ping Wu, Shenzhen (CN); Jingjing Tong, Foshan (CN)

(73) Assignee: WHIRLPOOL CORPORATION, BENTON HARBOR, MI (US)

(21) Appl. No.: 18/284,493

(22) PCT Filed: Apr. 13, 2021
(86) PCT No.: PCT/CN2021/086944

§ 371 Date: Sep. 27, 2023

(51) Int. Cl. H05B 6/64; F24C 15/00; F24C 15/16

(52) U.S. Cl. CPC H05B 6/647; F24C 15/005; F24C 15/166

(57) ABSTRACT

A compact appliance includes a housing that has a planar bottom surface and sidewalls that define a cavity. A cooking assembly is operably coupled to the housing. The cooking assembly includes heat conductors that are proximate to the planar bottom surface of the housing. A heating plate is operably coupled to the heat conductors and define a portion of the planar bottom surface of the housing. A seal is disposed around and coupled to the heating plate. A tray is selectively disposed within the cavity defined by the housing and removably coupled to the heating plate. The tray includes a ceramic coating.

### BACKGROUND OF THE DISCLOSURE

The present disclosure generally relates to a compact appliance, and more specifically, to a cooking assembly for a microwave oven.

### SUMMARY OF THE DISCLOSURE

According to one aspect of the present disclosure, a microwave oven includes a housing that has an upper portion, a lower portion, and a cavity that is defined by the upper portion and the lower portion. A tray is selectively disposed within the cavity and has a support surface and projections that are defined along the support surface. The support surface includes a ceramic coating that is configured to minimize sticking of a food item on the tray. A heating plate is disposed proximate to the tray and is operably coupled to the lower portion of the housing. The heating plate has an engagement surface and includes a metal oxide coating that is disposed along the engagement surface. Heat conductors are operably coupled to the heating plate. The heat conductors are in thermal communication with the heating plate.

According to another aspect of the present disclosure, a cooking assembly for a microwave oven includes a housing that has a planar bottom surface. A power supply is operably coupled to the housing that is proximate the planar bottom surface. A heating plate has a first surface and a second surface. A metal oxide coating is disposed on the first surface. Electrical heat conductors are operably coupled to the heating plate and in electrical communication with the power supply. The electrical heat conductors are configured to define heat along the metal oxide coating. A tray is operably coupled to the heating plate and includes a peripheral wall and a support surface. A ceramic coating is disposed on the support surface.

According to yet another aspect of the present disclosure, a compact appliance includes a housing that has a planar bottom surface and sidewalls that define a cavity. A cooking assembly is operably coupled to the housing. The cooking assembly includes heat conductors that are proximate to the planar bottom surface of the housing. A heating plate is operably coupled to the heat conductors and define a portion of the planar bottom surface of the housing. A seal is disposed around and coupled to the heating plate. A tray is selectively disposed within the cavity defined by the housing and removably coupled to the heating plate. The tray includes a ceramic coating.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top perspective view of a cooking appliance of the present disclosure;

FIG. 2 is a bottom perspective view of the cooking appliance of FIG. 1;

FIG. 3 is a top perspective view of the cooking appliance of FIG. 1 with an outer shell removed;

FIG. 4 is a side cross-sectional view of a cooking appliance of the present disclosure with a tray disposed on a heating plate;

FIG. 5 is an enlarged partial cross-sectional view of the tray and the heating plate taken at area V of FIG. 4;

FIG. 6 is a front cross-sectional view of a cooking appliance of the present disclosure with a microwave system, a heating plate, and a tray;

FIG. 7 is an enlarged partial cross-sectional view of the tray and heating plate of FIG. 6 taken at area VII with a power source of the present disclosure coupled to the heating plate;

FIG. 8 is a top perspective view of a heating plate of the present disclosure with a metal oxide coating;

FIG. 9 is a top perspective view of heat conductors of the present disclosure with the heating plate of FIG. 8 in phantom;

FIG. 10 is a top perspective view of a tray of the present disclosure with a ceramic coating and projections defined along the tray;

FIG. 11 is a top perspective of a cooking appliance of the present disclosure with a food item disposed on a tray;

FIG. 12 is an enlarged partial top perspective view of the food item on the tray of FIG. 11 taken at area XII; and

FIG. 13 is a schematic block diagram of a cooking assembly of the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a cooking assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

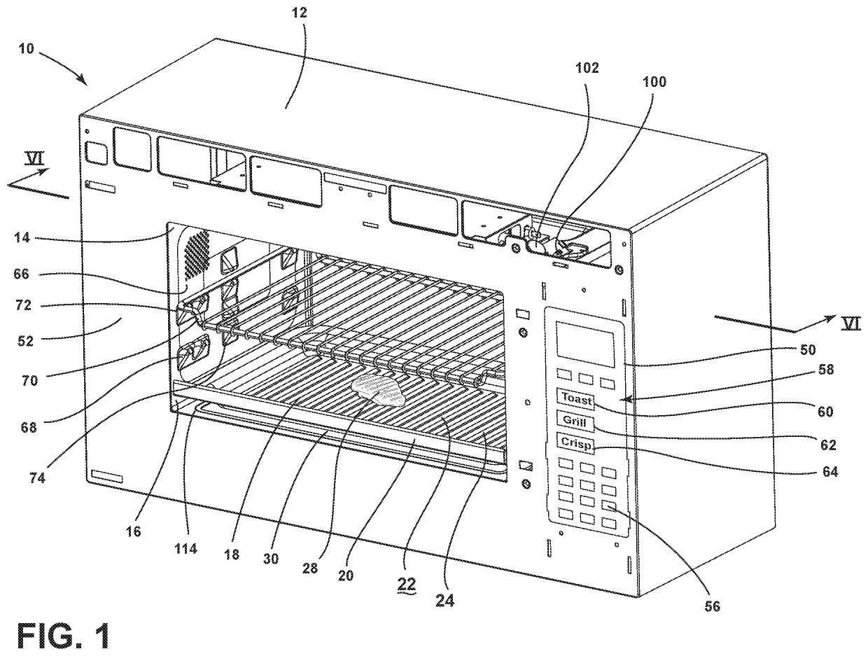

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

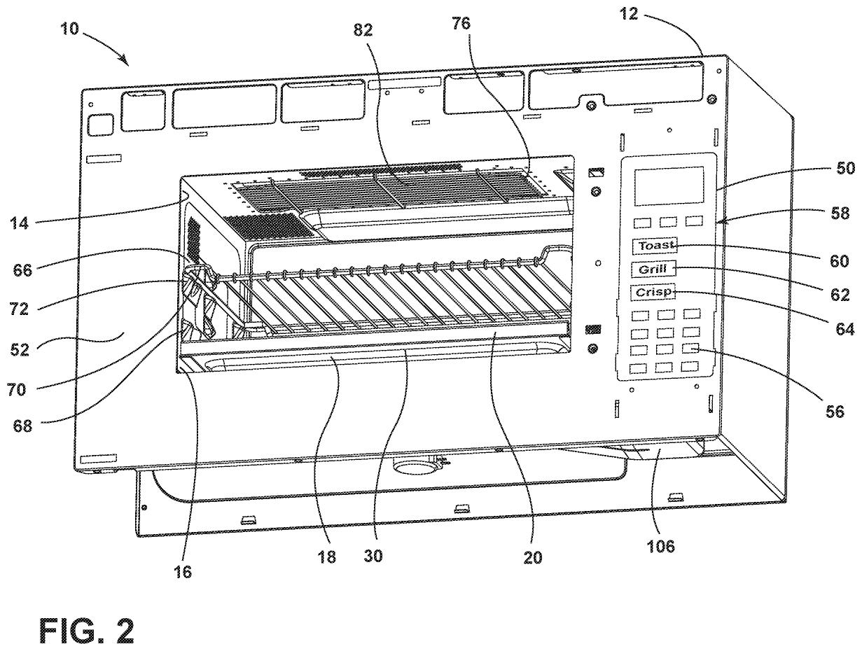

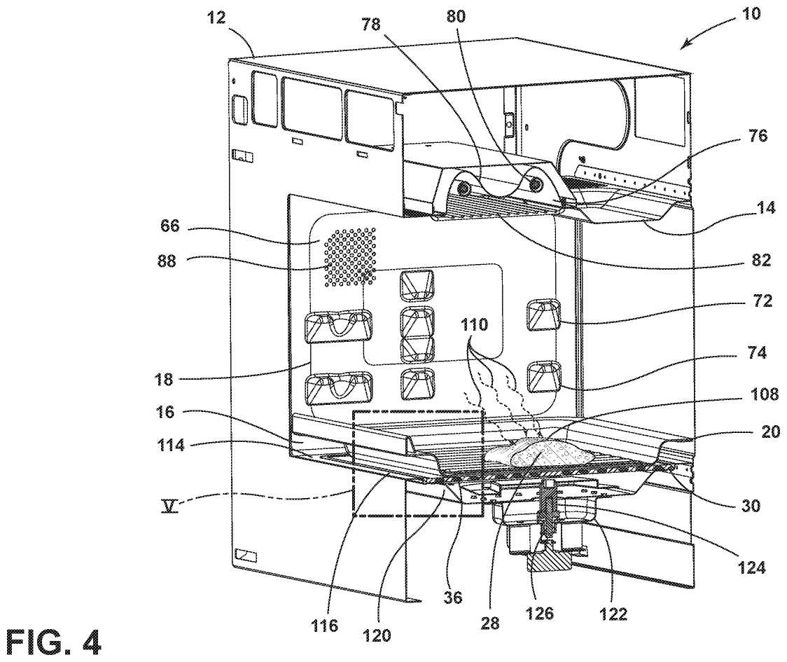

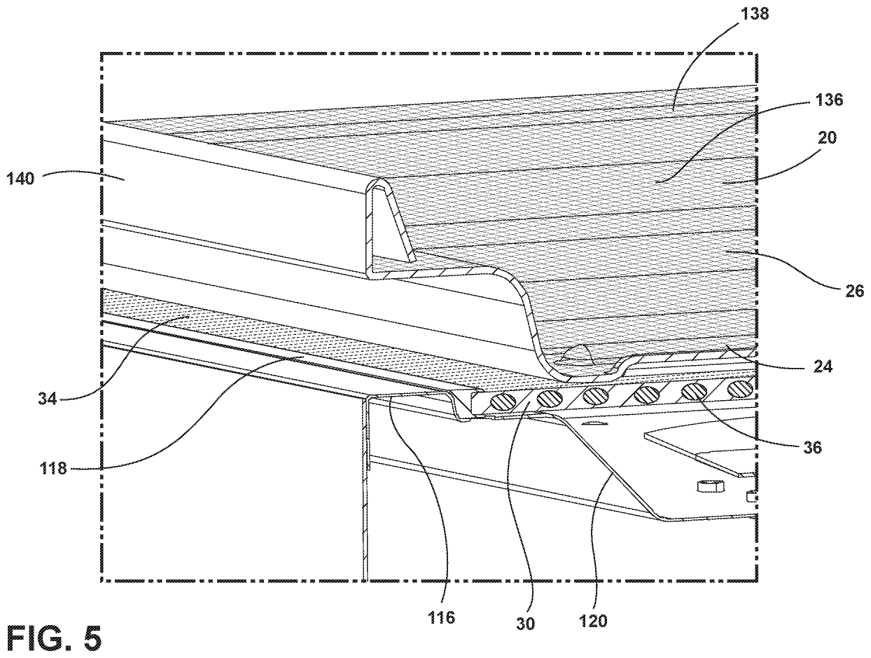

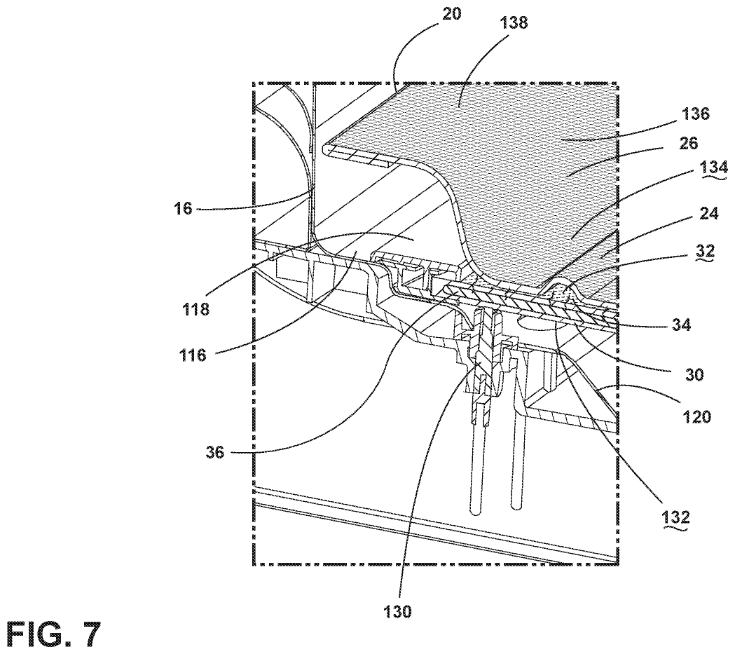

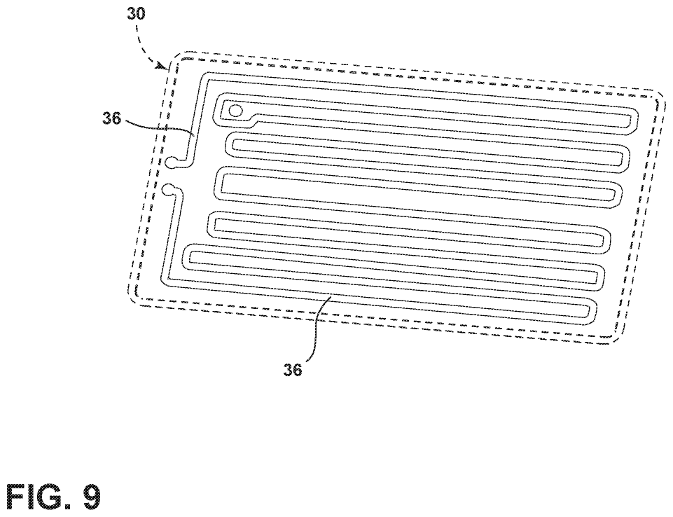

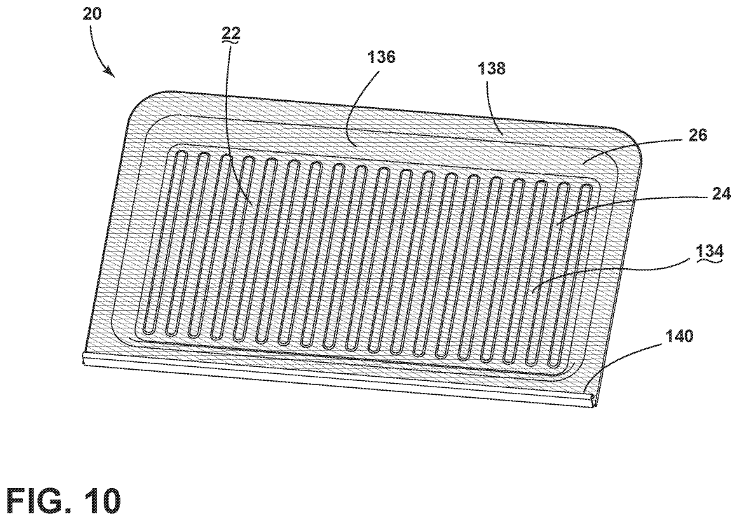

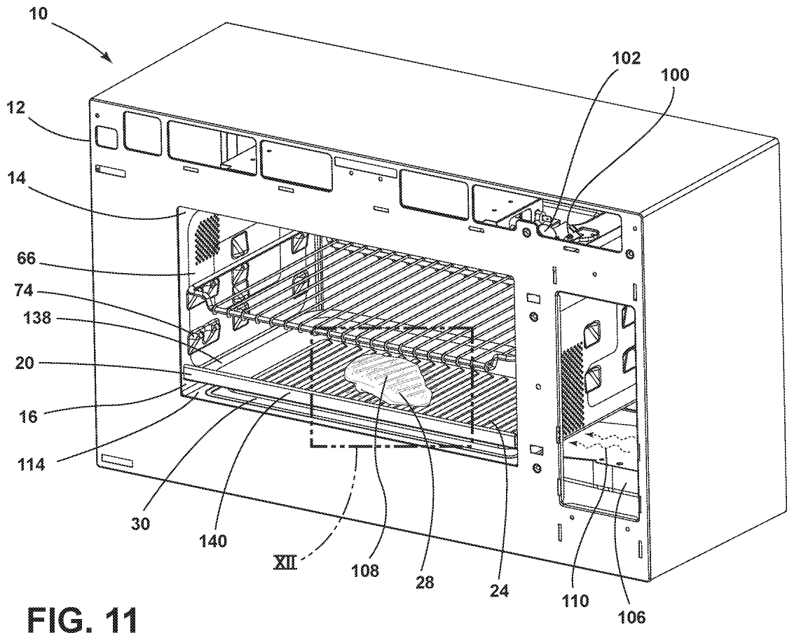

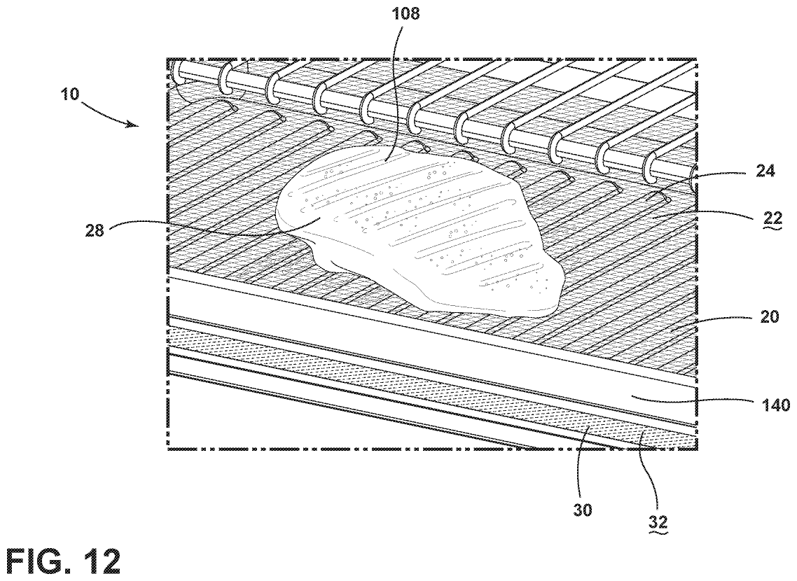

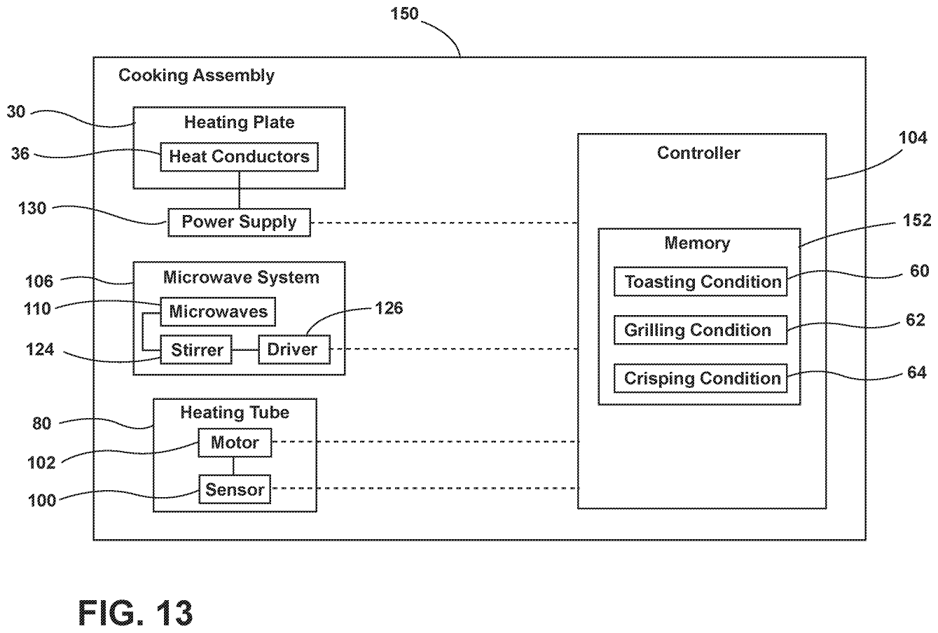

Referring to FIGS. 1-13, reference numeral 10 generally designates a microwave oven that includes a housing 12. The housing 12 has an upper portion 14, a lower portion 16, and a cavity 18 defined by the upper portion 14 and the lower portion 16. A tray 20 is selectively disposed within the cavity 18. The tray 20 has a support surface 22 and projections 24 defined along the support surface 22. The support surface 22 includes a ceramic coating 26 that is configured to minimize sticking of a food item 28 on the tray 20. A heating plate 30 is disposed proximate to the tray 20 and is operably coupled to the lower portion 16 of the housing 12. The heating plate 30 has an engagement surface 32 and includes a metal oxide coating 34 disposed along the engagement surface 32. Heat conductors 36 are operably coupled to the housing 12 and are in thermal communication with the heating plate 30.

Referring to FIGS. 1-4, the microwave oven 10 may be referred to as a compact cooking appliance and/or a compact appliance. It is generally contemplated that the microwave oven 10 may be a countertop microwave a wall-mounted microwave, and/or a microwave hood combination. As mentioned above, the compact appliance 10 includes the housing 12, which has a user interface 50 defined along a front surface 52 of the housing 12. The user interface 50 may include buttons 56 that generally correspond to cooking conditions 58 of the compact appliance 10. For example, the user interface 50 may include buttons 56 for a toasting condition 60 of the compact appliance 10. It is also contemplated that the user interface 50 may include buttons 56 for a grilling condition 62 and a crisping condition 64. The cooking conditions 58 of the compact appliance 10 are described in more detail below with respect to the heating plate 30.

The housing 12 also includes sidewalls 66 that generally separate the upper portion 14 from the lower portion 16. The sidewalls 66 may include protrusions 68 on which a rack 70 may be positioned. The protrusions 68 may be positioned proximate to the upper portion 14 and/or proximate to the lower portion 16. The protrusions 68 disposed proximate to the upper portion 14 may be referred to as upper protrusions 72, and the protrusions 68 disposed proximate to the lower portion 16 may be referred to as lower protrusions 74. It is generally contemplated that the rack 70 may be operably coupled to the upper protrusions 72, and the tray 20 may be operably coupled to the lower protrusions 74. Additionally or alternatively, the rack 70 and the tray 20 may both be coupled to the lower protrusions 74.

Referring still to FIGS. 1-4, the upper portion 14 of the housing 12 defines an opening 76 in which a reflector 78 and a heating tube 80 are disposed. The opening 76 is covered by a grate 82 operably coupled to the upper portion 14 of the housing 12. The grate 82 covers the reflector 78 and the heating tube 80. The grate 82 is illustrated as bars extending over the opening 76. It is also contemplated that the grate 82 may be a mesh or other practicable cover feature. The sidewalls 66 also define a plurality of apertures 88 through which air may pass to assist in the convection within the cavity 18 defined by the housing 12. The upper portion 14 of the housing 12 may also define the plurality of apertures 88 to assist in ventilation and other air movement within the cavity 18.

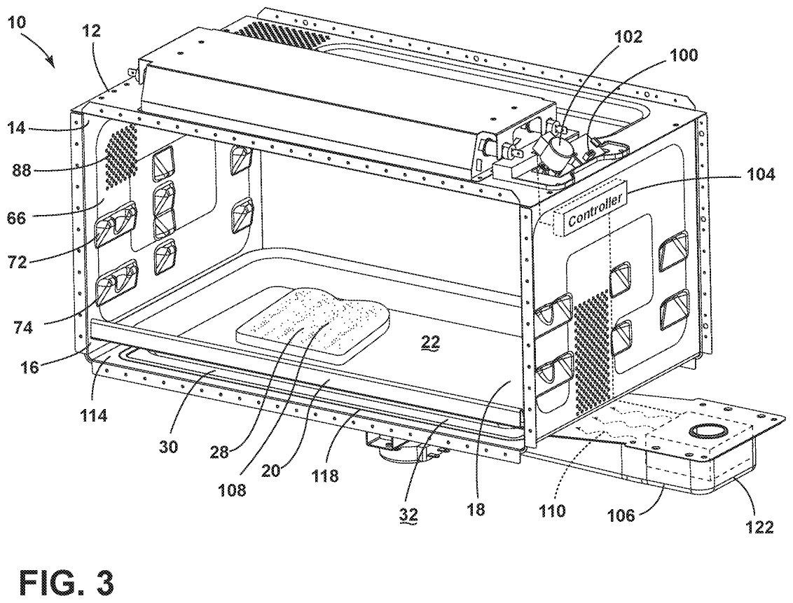

Referring now to FIGS. 3-6, the compact appliance 10 includes a sensor 100 operably coupled to the heating tube 80 and a motor 102 operably coupled to each of the sensor 100 and the heating tube 80. The motor 102 is configured to activate the heating tube 80 and is operably coupled to a controller 104 of the compact appliance 10. The heating tube 80 works in conjunction with the reflector 78 to dispense heat within the cavity 18. The sensor 100 detects the heat within the cavity 18 and is configured to communicate with the motor 102 via the controller 104. The controller 104 and the motor 102 are configured to activate and deactivate the heating tube 80 based on the temperature detected by the sensor 100 within the cavity 18. The reflector 78 assists in dispersing the heat emitted by the heating tube 80 within the cavity 18 and may assist in cooking functions of the compact appliance 10, such as grilling and/or broiling.

The heating tube 80 works in combination with a microwave system 106 of the compact appliance 10 to cook and/or otherwise heat the food item 28 within the cavity 18. For example, the heating tube 80 may utilize infrared radiation to heat an outer surface 108 of the food item 28 while microwaves 110 of the microwave system 106 penetrate the food item 28 to more centrally cook and/or heat the food item 28. Stated differently, the heating tube 80 may assist in browning the outer surface 108 of the food item 28 within the compact appliance 10, while the microwaves 110 can centrally cook the food item 28. It is generally contemplated that the microwaves 110 may penetrate approximately 1-centimeter into the food item 28. It is also contemplated that the microwaves 110 may be calibrated to penetrate greater than 1-centimeter and/or less than 1-centimeter. A center of the food item 28 is generally heated by the heat conducted from the portion of the food item 28 penetrated by the microwaves 110.

Referring still to FIGS. 3-6, the lower portion 16 of the housing 12 defines a bottom surface 114 of the housing 12 on which the tray 20 may be disposed. The heating plate 30 is operably coupled to the lower portion 16 of the housing 12 to at least partially define the bottom surface 114 of the housing 12. It is generally contemplated that the heating plate 30 is planar along the bottom surface 114 of the housing 12, such that the bottom surface 114 may be described as a planar bottom surface 114. The housing 12 is illustrated as defining a perimeter frame 116 around the heating plate 30, such that the heating plate 30 is centrally disposed within the perimeter frame 116 to define the bottom surface 114 of the housing 12.

Additionally or alternatively, the heating plate 30 may extend along the lower portion 16 of the housing 12, between the sidewalls 66, such that the heating plate 30 defines the entire bottom surface 114 of the housing 12. As illustrated in FIG. 3, the heating plate 30 includes a seal 118 disposed around the heating plate 30 between the heating plate 30 and the bottom surface 114 of the housing 12. It is generally contemplated that the seal 118 may be formed from silicone, rubber, and or other practicable materials configured for sealing the heating plate 30 along the bottom surface 114 of the housing 12.

With further reference to FIGS. 3-6, the lower portion 16 of the housing 12 may include the perimeter frame 116 and a recessed portion 120, which is generally concealed by the heating plate 30. The microwave system 106, mentioned above, is operably coupled to the recessed portion 120 of the housing 12. The microwave system 106 includes a wave housing 122 and a stirrer 124 that is operably coupled to the heat conductors 36. The stirrer 124 is operably coupled to the lower portion 16 of the housing 12 that is configured to reflect the microwaves 110 to be dispersed within the cavity 18. The stirrer 124 assists in evenly distributing the microwaves 110 about the food item 28 within the cavity 18. The stirrer 124 is operably coupled to a driver 126 that is communicatively coupled to the controller 104. The controller 104 can receive an input from the user via one of the buttons 56 (FIG. 1) to activate the microwave system 106. The controller 104 activates the driver 126 in combination with the microwave system 106 to actuate the stirrer 124. The microwaves 110 of the microwave system 106 are circulated within the cavity 18 via the stirrer 124 to, at least partially, cook the food item 28.

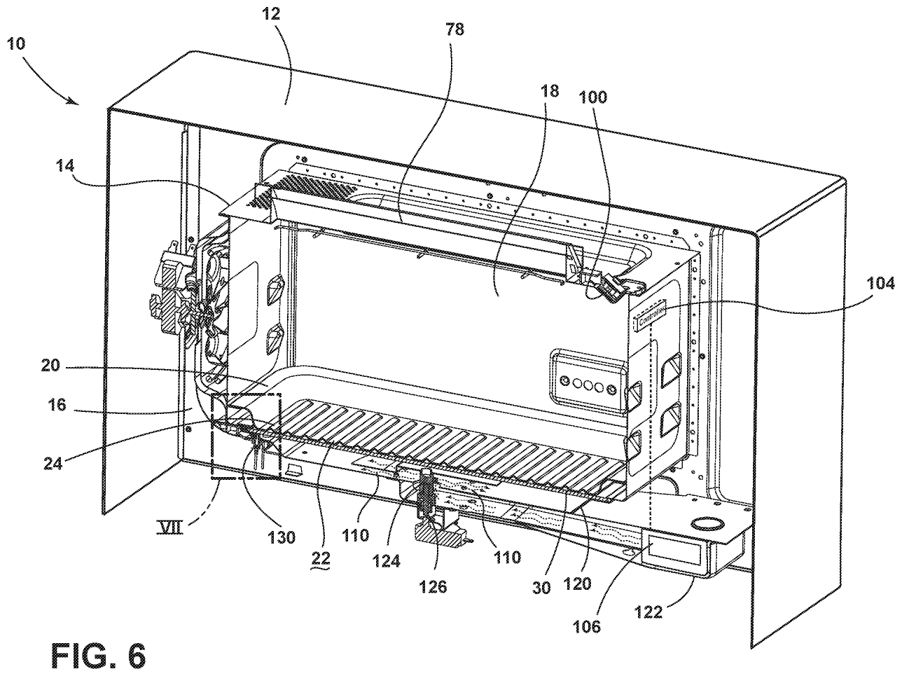

Referring now to FIGS. 6-9, a power supply 130 disposed in the lower portion 16 of the housing 12 and is electrically coupled to the heating plate 30. The power supply 130 may be at least partially disposed within the recessed portion 120 beneath the heating plate 30. It is generally contemplated that the power supply 130 is operably coupled to the heat conductors 36 operably coupled to the heating plate 30. The power supply 130 may electrically communicate with the heat conductors 36 to thermally conduct heat along the heating plate 30, as described in more detail below. Stated differently, the heat conductors 36 dissipate heat when activated by the power supply 130. The heat is then conducted via the heat conductors 36 along the heating plate 30, described below, and, ultimately, throughout the cavity 18 of the compact appliance 10.

The heating plate 30, as mentioned above, has the engagement surface 32 that may be defined as the first surface 32 of the heating plate 30, and the heating plate 30 also has a second surface 132. As mentioned above, the heating plate 30 has the metal oxide coating 34 disposed on at least the first surface 32 of the heating plate 30. Additionally or alternatively, the heating plate 30 may include the metal oxide coating 34 on both the first surface 32 and the second surface 132. It contemplated that the metal oxide coating 34 may alternatively be a carbon-nanotube coating and/or a graphene coating. It is also generally contemplated that the second surface 132 may be free of the metal oxide coating 34 to minimize heat conduction along the second surface 132. For example, the heating plate 30 is generally formed from a non-conductive ceramic material. The heating plate 30 may also be formed from a glass, glass-ceramic material, and/or any other practicable material configured for withstanding high temperatures.

With further reference to FIGS. 6-9, the tray 20 may be positioned on the engagement surface 32 of the heating plate 30 to be generally engaged with the heating plate 30. The engagement surface 32 is configured to support the tray 20 and to transfer heat from the heating plate 30 to the tray 20 via the metal oxide coating 34. and, ultimately, the food item 28. It is generally contemplated that the heat conducted along the engagement surface 32 is translated to the tray 20 as the heating plate 30. The heating plate 30 may be generally continuously covered with the metal oxide coating 34.

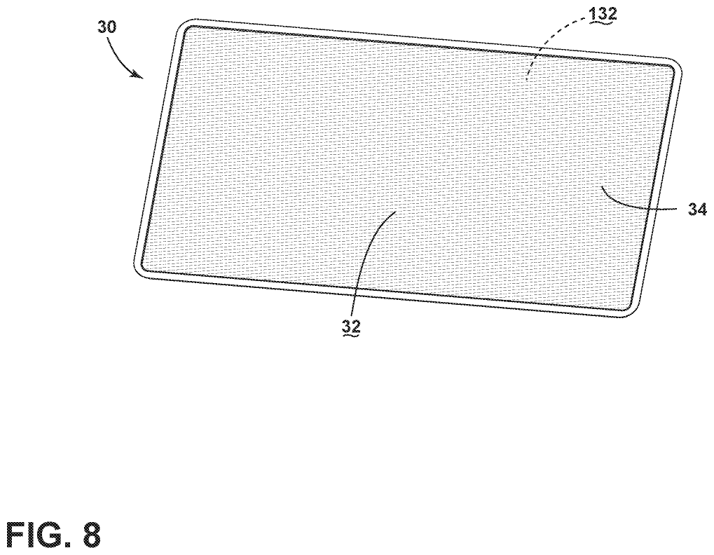

Referring now to FIGS. 8-12, the tray 20 is selectively disposed on the heating plate 30. As generally mentioned above, the tray 20 is configured to support the food item 28 along the support surface 22. The support surface 22 of the tray 20 is generally covered in the ceramic coating 26 to protect the tray 20 during various cooking cycles of the compact appliance 10. The ceramic coating 26 is configured to define a hardened surface 134 along at least the support surface 22 of the tray 20. It is also contemplated that the ceramic coating 26 may be disposed over the entirety of the tray 20. The ceramic coating 26 is advantageously applied to the support surface 22 to minimize sticking and build-up of oil or other excretions from the food item 28 disposed on the tray 20.

The tray 20 is typically formed from an aluminum material configured to conduct the heat from the heating plate 30 to the food item 28. It is generally contemplated that aluminum may be used for formation of the tray 20, as aluminum has a high rate of conductivity. The tray 20 may be formed via a stamp or process to define the support surface 22 and to define a peripheral wall 136 around the support surface 22. A flange 138 extends outwardly from the peripheral wall 136 and can selectively couple the tray 20 to the sidewalls 66 of the compact appliance 10. For example, the flange 138 may be disposed on at least the lower protrusions 74 defined by the lower portion 16 of the compact appliance 10. The flange 138 retains the tray 20 relative to the sidewalls 66 of the compact appliance 10, while also maintaining the engagement between the tray 20 and the heating plate 30.

Referring still to FIGS. 8-12, the tray 20 also defines a grasping portion 140 that upwardly extends from the flange 138 proximate the front surface 52 of the compact appliance 10. The grasping portion 140 can assist the user in removing the tray 20 from the compact appliance 10. It is generally contemplated that the grasping portion 140 is formed from aluminum during the stamping process of the tray 20. Additionally or alternatively, the grasping portion 140 may be covered in a silicone, rubber, or other insulation material to insulate the grasping portion 140 from the heat conducted by the heating plate 30.

As mentioned above, the ceramic coating 26 is disposed on the tray 20 and configured to minimize sticking of the food item 28 on the support surface 22 of the tray 20. By way of example, not limitation, the ceramic coating 24 may be formed from a sol-gel coating. The ceramic coating 26 generally has a high heat of resistance, such that the heat of resistance of the ceramic coating 26 is greater than approximately 400° C. The ceramic coating 26 is also contemplated to have a high scratch resistance, such that the ceramic coating 26 may be referred to as a hard coating that is generally resistant to scratches to define the hardened surface 134 of the tray 20. The peripheral wall 136 of the tray 20 is configured to minimize spilling of oil or other excretions of the food item 28 from the tray 20 onto the heating plate 30.

In addition to the peripheral wall 136 and the flange 138, the projections 24 may also be defined along the support surface 22 via the stamping or other formation process of the tray 20. The projections 24 are configured to raise the food item 28, such that the food item 28 is set above the support surface 22. The projections 24 assist in separating the food item 28 from the oil or other food excretions that may be collected along the support surface 22. The projections 24 are typically used during the grilling condition 62 (FIG. 1) of the compact appliance 10, such that the projections 24 assist in the grilling process of the food item 28 on the tray 20 in conjunction with the heating plate 30.

Referring again to FIGS. 1-13, the cooperation of the heating plate 30 with the tray 20 is configured to execute each of the toasting condition 60, the grilling condition 62 and the crisping condition 64 of the compact appliance 10. Specifically, the position of the heating plate 30 as the bottom surface 114 of the housing 12 can heat the food item 28 on the tray 20 from both the bottom surface 114 as well as from the upper portion 14 of the housing 12. Specifically, the heating plate 30 can work in combination with the heating tube 80 described above, which is positioned in the upper portion 14 of the housing 12. Further, the direct placement of the tray 20 on the heating plate 30 maximizes the heat conduction between the heating plate 30 and the tray 20. The direct contact between the tray 20 and the heating plate 30 allows the heating plate 30 to execute the toasting condition 60 separate from the grilling condition 62 and/or the crisping condition 64, as well as separate from the overall microwave system 106.

For example, the user may select the toasting condition 60 on the user interface 50, and the heating plate 30 is activated to toast the food item 28 on the tray 20 via conduction along the support surface 22. The heat conductors 36 disposed within the heating plate 30 are activated via the controller 104 and are configured to evenly distribute heat along the heating plate 30. The heat is conducted via the metal oxide coating 34 disposed along the heating plate 30 to conduct the heat to the tray 20. In the toasting condition 60, the heat supplied by the heating plate 30 is adjusted and controlled via the controller 104 that is in electrical communication with the power supply 130 of the heating plate 30.

With further reference to FIGS. 1-13, it is generally contemplated that the user interface 50 may provide various selections of the toasting condition 60, such that the user may select various levels of toasting for the food item 28. For example, the user may select a light, medium, or dark toast option, such that the heating plate 30 may adjust the heat conducted to toast the food item 28 on the tray 20 to a selected toast level. The toast level may be detected by the sensors 100 disposed in the upper portion 14 of the housing 12, which are in communication with the controller 104. The sensors 100 may detect when the food item 28, has reached the selected toast level, and the controller 104 may then turn off the electrical power source operably coupled to the heating plate 30. It is further contemplated that the heating tube 80 positioned in the upper portion 14 of the housing 12 may also cooperate with the heating plate 30 to execute the toasting condition selected by the user.

It is generally contemplated that a similar process of activating and deactivating the heating plate 30 is used during the crisping condition 64 of the compact appliance 10. The heating plate 30 is configured to conduct heat to the tray 20 via the metal oxide coating 34 in a manner to execute a crisp on the outer surface 108 of the food item 28. Similar to the toasting condition 60, the crisping condition 64 of the compact appliance 10 may utilize the heating tube 80 in combination with the heating plate 30 to crisp the outer surface 108 of the food item 28. Both the toasting condition 60 and the crisping condition 64 may be optionally executed in combination with the microwave system 106. Alternatively, each of the toasting condition 60 and the crisping condition 64 may be executed independent of the microwave system 106.

With further reference to FIGS. 1-13, a similar process can be executed for the grilling condition 62 when selected by the user on the user interface 50. In the grilling condition 62, the heating tube 80 cooperates with the heating plate 30 to grill the food item 28 disposed on the tray 20. It is generally contemplated that the tray 20 used for the grilling condition 62 includes the projections 24 defined along the support surface 22. Typically, the food items 28 may excrete oils or other juices during the grilling process that are preferably separated from the food item 28. Positioning the food item 28 on the projections 24 elevates the food item 28 above the support surface 22 on which the oils and/or juices may collect.

The controller 104 activates the electrical power source for the heating plate 30 when the grilling condition 62 is selected on the user interface 50. It is generally contemplated that the heating plate 30 is configured to heat the tray 20 to a temperature greater than that used for the toasting condition 60. Additionally or alternatively, the heating plate 30 may be configured to heat the tray 20 to a temperature that is generally less than or equal to that of the temperature used during the toasting condition 60. The grilling condition 62 is executed in combination of the heating plate 30 and the heating tube 80 in the upper portion 14 of the housing 12. The heating plate 30 is configured to cook the food item 28 via the bottom surface 114 of the housing 12, while the heating tube 80 is configured to cook the food item 28 from the upper portion 14 of the housing 12. The grilling condition 62 may be executed over a longer period of time in order to fully cook the food item 28. Additionally or alternatively, the grilling condition 62 may be executed in combination with the microwave system 106 to cook the food item 28 in a shorter period of time.

For example, the microwave system 106 may be utilized to generally cook the central portion of the food item 28, while the heating plate 30 and the heating tube 80 are configured to grill and cook the outer surface 108 of the food item 28. The heating plate 30 is configured to form a crisp or grilled outer surface 108 of the food item 28, while also cooking the food item 28 on the tray 20. The metal oxide coating 34 disposed on the heating plate 30 conducts the heat from the heating plate 30 to the tray 20 to evenly and more directly cook the food item 28 on the tray 20.

Referring still to FIGS. 1-13, the direct placement of the tray 20 on the heating plate 30 with the metal oxide coating 34 maximizes the application of heat to the food item 28 as opposed to the general heat conduction within the cavity 18 via the heating tube 80. The direct placement of the tray 20 on the heating plate 30 allows the food item 28 to cook more evenly and retain a crisp exterior. The projections 24 are defined along the support surface 22 of the tray 20 to further assist in maintaining the general crispness of the outer surface 108 of the food item 28. As mentioned above, the projections 24 generally separate the food item 28 of any oils or excretions that may be collected along the support surface 22 of the tray 20 during the cooking process of the food item 28.

The heating plate 30 and the tray 20 generally define a cooking assembly 150 for the microwave oven 10. The cooking assembly 150 is utilized to execute any one of the toasting condition 60, the grilling condition 62, and/or the crisping condition 64. It is generally contemplated that each of the toasting condition 60, the grilling condition 62, and the crisping condition 64 are stored in a memory 152 of the controller 104. The positioning of the heating plate 30 within the lower portion 16 of the housing 12 to define the bottom surface 114 of the housing 12 further assists with executing each of the toasting condition 60, the grilling condition 62, and the crisping condition 64. The heating plate 30 is configured to conduct heat via the metal oxide coating 34 to cook the food item 28 from beneath the tray 20 in addition to the heating tube 80 positioned in the upper portion 14 of the housing 12. Further, the ceramic coating 26 disposed on the tray 20 minimizes sticking of the food item 28 on the tray 20 while the food item 28 is cooked or otherwise heated from the bottom surface 114 of the housing 12 via the heating plate 30. The addition of the projections 24 further assists in the overall cooking process of the food item 28 by raising the food item 28 above the support surface 22 of the tray 20.

The invention disclosed herein is further summarized in the following paragraphs and is further characterized by combinations of any and all of the various aspects described therein.

According to one aspect of the present disclosure, a microwave oven includes a housing that has an upper portion, a lower portion, and a cavity that is defined by the upper portion and the lower portion. A tray is selectively disposed within the cavity and has a support surface and projections that are defined along the support surface. The support surface includes a ceramic coating that is configured to minimize sticking of a food item on the tray. A heating plate is disposed proximate to the tray and is operably coupled to the lower portion of the housing. The heating plate has an engagement surface and includes a metal oxide coating that is disposed along the engagement surface. Heat conductors are operably coupled to the heating plate. The heat conductors are in thermal communication with the heating plate.

According to another aspect, a heating plate at least partially defines a lower portion of a housing.

According to another aspect, a heating plate is configured to project heat via a lower portion of the housing.

According to another aspect, a tray is selectively disposed on an engagement surface of a heating plate, and heat conductors are in thermal communication with the tray via a metal oxide coating that is disposed on the engagement surface of the heating plate.

According to another aspect, a power supply is in electrical communication with heat conductors. The power supply is configured to define heat along a metal oxide coating of a heating plate via the electrical heat conductors.

According to another aspect, a housing includes a bottom surface that is defined by a heating plate, and a bottom surface is a planar surface.

According to another aspect, a seal is disposed around a heating plate to further define a bottom surface of a housing.

According to another aspect of the present disclosure, a cooking assembly for a microwave oven includes a housing that has a planar bottom surface. A power supply is operably coupled to the housing that is proximate the planar bottom surface. A heating plate has a first surface and a second surface. A metal oxide coating is disposed on the first surface. Electrical heat conducts are operably coupled to the heating plate and in electrical communication with the power supply. The electrical heat conductors are configured to define heat along the metal oxide coating. A tray is operably coupled to the heating plate and includes a peripheral wall and a support surface. A ceramic coating is disposed on the support surface.

According to another aspect, a tray also includes a flange that outwardly extends from a peripheral wall.

According to another aspect, a support surface is recessed relative to a flange and a peripheral wall, and a tray is operably coupled to a heating plate via a support surface and is operably coupled to a housing via the flange.

According to another aspect, a heating plate defines a planar bottom surface of a housing.

According to another aspect, electrical heat conductors define heat along a heating plate via conduction with a metal oxide coating.

According to another aspect, a heating plate is configured to at least one of toast, grill, and crisp a food item that is disposed on a tray.

According to another aspect, a tray has projection that are defined along a support surface.

According to yet another aspect of the present disclosure, a compact appliance includes a housing that has a planar bottom surface and sidewalls that define a cavity. A cooking assembly is operably coupled to the housing. The cooking assembly includes heat conductors that are proximate to the planar bottom surface of the housing. A heating plate is operably coupled to the heat conductors and define a portion of the planar bottom surface of the housing. A seal is disposed around and coupled to the heating plate. A tray is selectively disposed within the cavity defined by the housing and removably coupled to the heating plate. The tray includes a ceramic coating.

According to another aspect, a heating plate includes an engagement surface, and a metal oxide coating is disposed on the engagement surface.

According to another aspect, heat conductors are thermally coupled to a metal oxide coating to define heat along an engagement surface of a heating plate.

According to another aspect, a heating plate is in thermal communication with a tray via a metal oxide coating and heat conductors.

According to another aspect, a ceramic coating of a tray is configured to minimize sticking between a food item and a tray.

According to another aspect, a tray includes a peripheral wall and a support surface, and the peripheral wall has a flange that is operably coupled to sidewalls of a housing and a ceramic coating is disposed on a support surface of a tray.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed:

1. A microwave oven, comprising:
a housing having an upper portion, a lower portion, and a cavity defined by the upper portion and the lower portion;
a tray selectively disposed within the cavity and having a support surface and projections defined along the support surface, the support surface including a ceramic coating configured to minimize sticking of a food item on the tray;
a heating plate disposed proximate to the tray and operably coupled to the lower portion of the housing, the heating plate having an engagement surface and including a metal oxide coating disposed along the engagement surface; and
heat conductors operably coupled to the heating plate, wherein the heat conductors are in thermal communication with the heating plate.

2. The microwave oven of claim 1, wherein the heating plate at least partially defines the lower portion of the housing.

3. The microwave oven of claim 1, wherein the heating plate is configured to project heat via the lower portion of the housing.

4. The microwave oven of claim 1, wherein the tray is selectively disposed on the engagement surface of the heating plate, and wherein the heat conductors are in thermal communication with the tray via the metal oxide coating disposed on the engagement surface of the heating plate.

5. The microwave oven of claim 1, further comprising:
a power supply in electrical communication with the heat conductors, wherein the power supply is configured to define heat along the metal oxide coating of the heating plate via the electrical heat conductors.

6. The microwave oven of claim 1, wherein the housing includes a bottom surface defined by the heating plate, and wherein the bottom surface is a planar surface.

7. The microwave oven of claim 6, further comprising:
a seal disposed around the heating plate to further define the bottom surface of the housing.

8. A cooking assembly for a microwave oven, the cooking assembly comprising:
a housing having a planar bottom surface;
a power supply operably coupled to the housing proximate the planar bottom surface;
a heating plate having a first surface and a second surface, wherein a metal oxide coating is disposed on the first surface;
electrical heat conductors operably coupled to the heating plate and in electrical communication with the power supply, wherein the electrical heat conductors are configured to define heat along the metal oxide coating; and
a tray operably coupled to the heating plate and including a peripheral wall and a support surface, wherein a ceramic coating is disposed on the support surface.

9. The cooking assembly of claim 8, wherein the tray also includes a flange outwardly extending from the peripheral wall.

10. The cooking assembly of claim 9, wherein the support surface is recessed relative to the flange and the peripheral wall, and wherein the tray is operably coupled to the heating plate via the support surface and operably coupled to the housing via the flange.

11. The cooking assembly of claim 8, wherein the heating plate defines the planar bottom surface of the housing.

12. The cooking assembly of claim 8, wherein the electrical heat conductors define the heat along the heating plate via conduction with the metal oxide coating.

13. The cooking assembly of claim 12, wherein the heating plate is configured to at least one of toast, grill, and crisp a food item disposed on the tray.

14. The cooking assembly of claim 8, wherein the tray has projections defined along the support surface.

15. A compact appliance, comprising:
a housing having a planar bottom surface and sidewalls that define a cavity;
a cooking assembly operably coupled to the housing, the cooking assembly including:
heat conductors proximate to the planar bottom surface of the housing;
a heating plate operably coupled to the heat conductors and defining a portion of the planar bottom surface of the housing; and
a seal disposed around and coupled to the heating plate; and
a tray selectively disposed within the cavity defined by the housing and removably coupled to the heating plate, the tray including a ceramic coating.

16. The compact appliance of claim 15, wherein the heating plate includes an engagement surface, and wherein a metal oxide coating is disposed on the engagement surface.

17. The compact appliance of claim 16, wherein the heat conductors are thermally coupled to the metal oxide coating to define heat along the engagement surface of the heating plate.

18. The compact appliance of claim 15, wherein the heating plate is in thermal communication with the tray via the metal oxide coating and the heat conductors.

19. The compact appliance of claim 15, wherein the ceramic coating of the tray is configured to minimize sticking between a food item and the tray.

20. The compact appliance of claim 15, wherein the tray includes a peripheral wall and a support surface, and wherein the peripheral wall has a flange operably coupled to the sidewalls of the housing and the ceramic coating is disposed on the support surface of the tray.
